(19) United States
(12) Patent Application Publication
(10) Pub. No.: US 2025/0334090 A1
(43) Pub. Date: Oct. 30, 2025

(54) ROCKET MOTOR ADDITIVE MANUFACTURING

(71) Applicant: Ursa Major Technologies, Inc., Berthoud, CO (US)

(72) Inventors: Paul G. Nistler, Arvada, CA (US); Austin P. Feathers, Loveland, CO (US)

(21) Appl. No.: 18/669,223

(22) Filed: May 20, 2024

Related U.S. Application Data
(63) Continuation of application No. PCT/US2024/026304, filed on Apr. 25, 2024.

(51) Int. Cl. F02K 9/34; B33Y 10/00; B33Y 40/00; B33Y 80/00

(52) U.S. Cl. CPC F02K 9/346; B33Y 10/00; B33Y 40/00; B33Y 80/00; F05D 2230/20; F05D 2240/35; F05D 2250/283; F05D 2260/30

(57) ABSTRACT

A rocket motor may include a combustion chamber configured to carry propellant for propelling the rocket. The rocket motor may include a motor case enclosing the combustion chamber, the motor case comprising an external wall that has an insulator-carrying surface. The rocket motor may include an ablative layer carried by the insulator-carrying surface of the wall of the motor case. The rocket motor may include a set of surface structures on the insulator-carrying surface. The set of surface structures are shaped to provide mechanical retention of the ablative layer. The motor case may include an internal wall that is spaced apart from the external wall to form a passage space between the internal wall and the external wall. The ablative layer is located in the passage space. The external wall and the internal wall may be a monolithic piece formed from an additive manufacturing process.

### CROSS-REFERENCE TO RELATED APPLICATION(S)

This application is a continuation of PCT application PCT/US2024/026304, filed on Apr. 25, 2024, which is incorporated by reference herein in its entirety for all purposes.

### TECHNICAL FIELD

The disclosure generally relates to examples of rocket motor structures.

### BACKGROUND

In the domain of rocketry and propulsion systems, shielding structural components from the intense thermal effects of combustion remains a pivotal consideration. Rocket motor design often involves the integration of effective insulation that separates the high-temperature combustion environment from the structural elements. Conventionally, the insulation layer is meticulously shaped to match the desired configuration and then adjoined to the interior of the motor case through adhesive bonding. However, forming the insulation layer and bonding the layer to the motor case often involve a labor-intensive process, such as including machining the motor case and shaping the insulation layer.

Furthermore, rocket motors often provide some form of protection to the propellant grain to inhibit combustion on the grain surfaces and to establish a mechanical linkage between the grain and the case. Conventionally, a rubber layer with mechanical properties similar to those of the propellant grain is used. The formation of this type of rubber layer may mitigate mechanical stress and strain on the grain. The interplay of insulating materials and the propellant grains underscores the continual pursuit of enhancing the performance, reliability, and safety of rocket motor cases within the aerospace domain.

### SUMMARY

Some embodiments described herein relate to a rocket motor that may include a combustion chamber configured to carry propellant for propelling the rocket. The rocket motor may also include a motor case enclosing the combustion chamber. The motor case may include a wall that has an insulator-carrying surface. The rocket motor may further include an ablative layer carried by the insulator-carrying surface of the wall of the motor case. The rocket motor may further include a set of surface structures on the insulator-carrying surface. The set of surface structures is shaped to provide mechanical retention of the ablative layer.

In some embodiments, the wall is an external wall, the motor case further includes an internal wall that is spaced apart from the external wall to form a passage space between the internal wall and the external wall, and the ablative layer is located in the passage space.

In some embodiments, the external wall and the internal wall are part of a monolithic piece formed from an additive manufacturing process.

In some embodiments, the ablative layer is formed of an ablative material that is injection molded into the passage space.

In some embodiments, the insulator-carrying surface faces the passage space.

In some embodiments, the internal wall is thinner than the external wall and is configured to be sacrificial during the combustion of the propellant.

In some embodiments, the set of surface structures includes a lattice surface structure.

In some embodiments, the set of surface structures includes a radially protruding member that has a first width that is wider than a second width at a level that is closer to the insulator-carrying surface.

In some embodiments, the propellant is a solid propellant grain that is in contact with a second wall of the motor case, and the second wall includes a liner structure that reduces the mechanical strength of the second wall.

In some embodiments, the second wall having the liner structure has a Young's modulus that is comparable to a Young's modulus of the solid propellant grain.

Some embodiments described herein relate to a method for making a rocket motor. The method may include performing an additive manufacturing process to form a motor case that includes a wall that has an insulator-carrying surface. The method may also include forming, as part of the additive manufacturing process, a set of surface structures on the insulator-carrying surface. The method may also include forming an ablative layer on the insulator-carrying surface of the wall of the motor case. The set of surface structures is formed by the additive manufacturing process to be shaped to provide mechanical retention of the ablative layer.

In some embodiments, the motor case is a monolithic piece that is formed by the additive manufacturing process, the monolithic piece includes the wall and an internal wall that is internal to and spaced apart from the wall to form a passage space between the wall and the internal wall, and the set of surface structures on the insulator-carrying surface faces the passage space.

In some embodiments, forming the ablative layer on the insulator-carrying surface of the wall of the motor case may include: injecting an ablative material into the passage space between the internal wall and the wall; and curing the ablative material to form an ablative layer between the internal wall and the wall of the motor case.

In some embodiments, the techniques described herein relate to a method, further including sealing the passage space to prevent the ablative material from outflowing from the passage space.

In some embodiments, the internal wall includes a liner structure that is formed as part of the additive manufacturing process.

In some embodiments, the motor case has a longitudinal body, and the additive manufacturing process is progressed along a longitudinal direction to build the motor case.

Some embodiments described herein relate to a rocket motor that may include a combustion chamber and a propellant grain carried inside the combustion chamber. The rocket motor may also include a motor case enclosing the combustion chamber. The motor case may include a metallic liner structure that is in contact with the propellant grain.

In some embodiments, the metallic liner structure is part of a monolithic piece of the motor case that is formed by additive manufacturing.

In some embodiments, the metallic liner structure has a reduced mechanical strength compared to a metallic wall without a liner structure.

In some embodiments, the motor case further includes an external wall and an internal wall that is spaced apart from the external wall to form a passage space between the internal wall and the external wall, an ablative layer is located in the passage space, and the metallic liner structure is on the internal wall.

### BRIEF DESCRIPTION OF THE DRAWINGS

FIG. 1 is a perspective of a rocket motor, in accordance with some embodiments.

FIG. 2 is a cross-sectional view of a rocket motor, in accordance with some embodiments.

FIG. 3 is a cutaway perspective view of an example motor case of a rocket motor, in accordance with some embodiments.

FIGS. 4A, 4B, and 4C are cross-sectional conceptual diagrams of various examples of surface structures of an external wall that are used to promote the mechanical retention of the ablative layer, in accordance with some embodiments.

FIG. 5A is a cutaway perspective view of an example motor case a rocket motor, in accordance with some embodiments.

FIG. 5B is a cross-sectional view of a rocket motor illustrating the line structure, in accordance with some embodiments.

FIG. 5C is a cut view of the motor case at the cross-section of FIG. 5B to further illustrate the liner structure, in accordance with some embodiments.

FIG. 6 is a flowchart depicting an example process for making a motor case, in accordance with some embodiments.

The figures depict, and the detailed description describes, various non-limiting embodiments for purposes of illustration only.

### DETAILED DESCRIPTION

The figures (FIGS.) and the following description relate to preferred embodiments by way of illustration only. One of skill in the art may recognize alternative embodiments of the structures and methods disclosed herein as viable alternatives that may be employed without departing from the principles of what is disclosed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

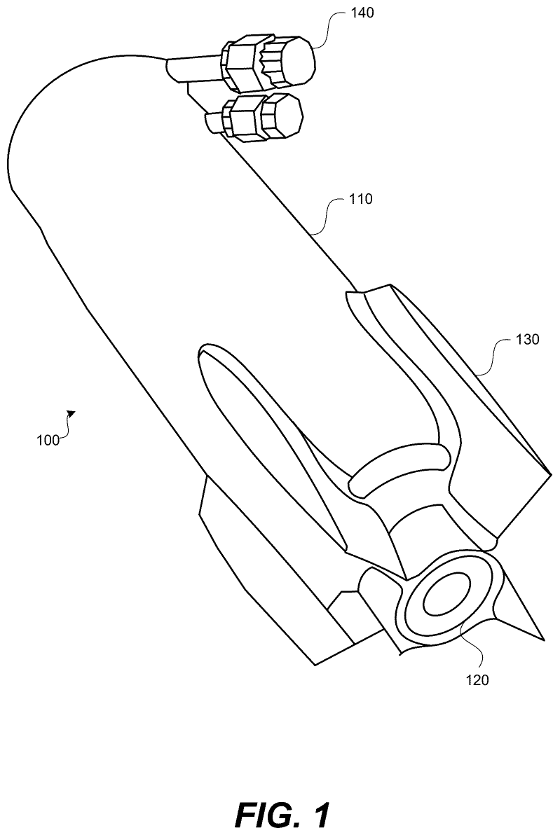

Conventionally, manufacturing a rocket motor is a labor-intensive process. A novel process is discussed in this disclosure to use an additive manufacturing process to form a novel structure of a rocket motor. By way of example, an additive manufacturing process may be used to 3D print a metallic dual-wall motor call. The two walls are spaced apart to form a space between the walls. Ablative material can be injected into the space and cured to form an ablative layer. Since an additive manufacturing process is used, the surface on one or more of the walls may be formed with complex patterns that enhance the mechanical retention of the ablative layer by the wall. In some embodiments, the inner wall of the motor case may also be formed as a metallic liner that has a mechanical strength that is comparable to the propellant grain to reduce the pressure exerted on the grain. Further details of various novel features will be discussed in association with FIG. 1 through FIG. 6.

### Rocket Motor Structure

FIG. 1 is a perspective of a rocket motor 100, in accordance with some embodiments. The rocket motor 100 may be a solid rocket motor that is designed to carry propellant grain. While solid rocket motors are used as the primary examples in this disclosure, various structures and manufacturing processes described in this disclosure may also be applied to other types of rocket motors that carry other types of propellants, such as liquid rocket engines, hybrid rocket motors, and other thrusters. In some embodiments, the rocket motor 100 may also be generally referred to as a rocket engine, a thruster, or a propulsion device. In various embodiments, a rocket motor 100 may be paired with any type of vehicle that uses a propulsion system, such as a missile, a space launch vehicle, a satellite launcher, or another suitable rocket. The rest of the vehicle is not shown in this disclosure.

In some embodiments, the rocket motor 100 may include a motor case 110, a nozzle 120, a set of rocket fins 130 for stability and aerodynamic control of the rocket, and one or more inlets 140 that are used for regulation and communication of materials inside the motor case 110. The motor case 110 may take the form of a longitudinal body that is extended in the longitudinal direction in which the nozzle 120 is located at the end of the motor case 110. As it will be further discussed below, the motor case 110 includes various structural features that extend in the radial direction towards the center of the rocket motor 100. The nozzle 120 may take any suitable form that is shaped and configured to convert the gas generated from the combustion of the propellant into a high-velocity jet of gas that creates thrust for the rocket motor 100. The rocket fins 130 and the inlets 140 are optional and may not be present in some embodiments. For example, as discussed in further detail below, one of the inlets 140 may be used for the injection of ablative material to form an insulation layer in the motor case 110. The inlet 140 may be sealed off or even removed after the injection and curing of the ablative material.

In this disclosure, various views and embodiments of the rocket motor 100 may be described with directional terms such as longitudinal direction, radial direction, external, internal, top, bottom, etc. The directional terms are not limited to a particular orientation and may simply mean relative terms for two or more different directions. As such, in some embodiments, the longitudinal direction and the radial direction may simply be described as the first direction and the second direction. For example, the use of the term radial direction may merely mean a direction towards or away from a center, but such use of the term does not imply that the body of the motor case 110 is rounded. The motor case 110 may take any suitable shape, round or polygonal, symmetrical or not, regular or irregular.

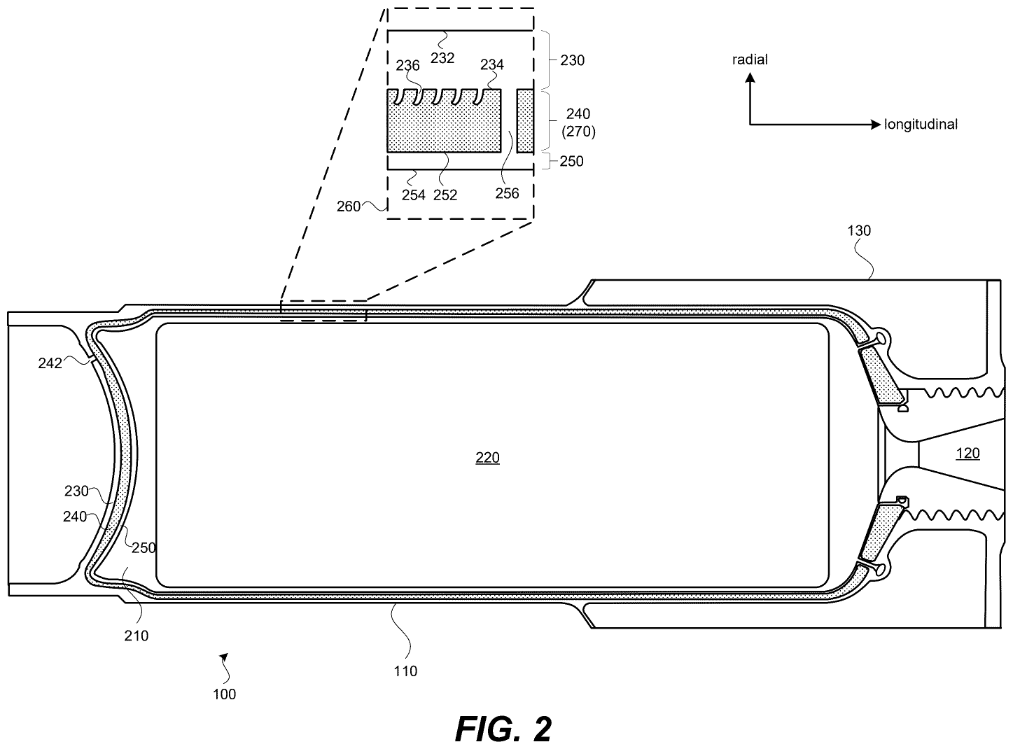

FIG. 2 is a cross-sectional view of a rocket motor 100, in accordance with some embodiments. As discussed in FIG. 1, the rocket motor 100 may include a motor case 110, a nozzle 120, and a set of rocket fins 130. As shown in FIG. 2, the rocket motor 100 may further include a combustion chamber 210 that carries a propellant grain 220 for propelling the rocket. The motor case 110 encloses the combustion chamber 210 and defines the space of the combustion chamber 210. The motor case 110 may include multiple layers, including an external wall 230, an ablative layer 240, and an internal wall 250. The precise arrangement among the external wall 230, the ablative layer 240, and the internal wall 250 are best shown in an enlarged view that is illustrated in the inset 260.

The propellant grain 220 may be one or more pieces of solidified fuel material that is combustible to generate thrust to propel the rocket. The materials of the propellant grain 220 are generally known in the art and may include a mixture of fuel and oxidizer compounds. The propellant grain 220 may take any suitable shape and may include multiple sub-grains that are arranged to be burned in a specific order to adjust the thrust profile of the rocket. The precise structure and shape of the propellant grain 220 is not illustrated in FIG. 2 and the propellant grain 220 is conceptually represented by a rectangle. In different embodiments, the precise shape and arrangement of the propellant grain 220 may vary. In some embodiments, the propellant grain 220 may be solidified from a fuel mixture solution and may have a low mechanical strength compared to the materials of the motor case 110. For example, the propellant grain 220 may be associated with a first value of Young's modulus that typically ranges from 100 PSI to 1000 PSI.

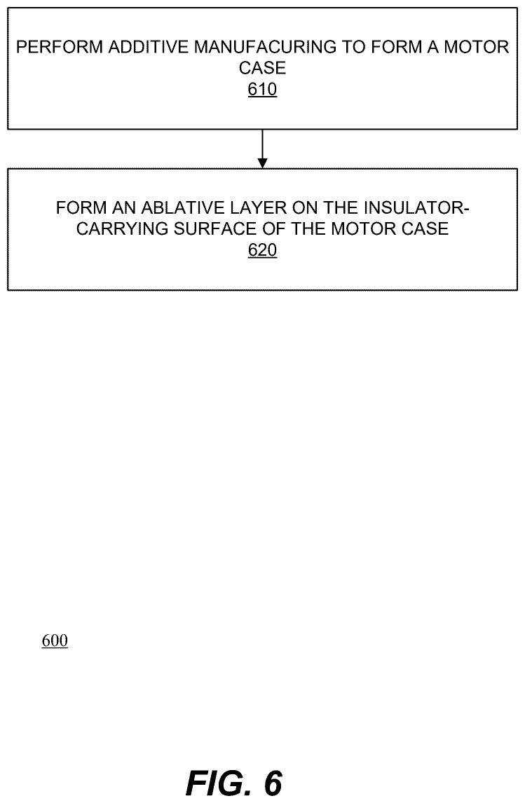

In some embodiments, the motor case 110 may include multiple layers that are formed in a specific manufacturing process that includes an additive manufacturing process and an injection molding process. For example, the layers of the motor case 110 may include the external wall 230, the ablative layer 240, and the internal wall 250. In some embodiments, an additive manufacturing process is performed to form the external wall 230 and internal wall 250 as a monolithic piece. The external wall 230 and the internal wall 250 are spaced apart to form a passage space 270 between the two walls. An ablative material is injected into the passage space 270 and cured between the external wall 230 and the internal wall 250 to form the ablative layer 240. The manufacturing process is further described below in FIG. 6.

Referring to the enlarged view illustrated by the inset 260, the external wall 230 may provide the structure support to the rocket motor 100. In some embodiments, while the wall 230 is referred to as the external wall 230, it may or may not be the outermost layer of the motor case 110. For example, in some embodiments, there may be an additional wall or layer, such as a cosmetic layer, coating, painting, and another insulation layer outside of the external wall 230. The external wall 230 is external to the ablative layer 240 and the internal wall 250 in at least the radial direction.

The external wall 230 may be the mechanical and structural piece of the motor case 110 and may also be referred to as the pressure-boundary wall. The external wall 230 may be formed of a suitable material and has a thickness that is responsible for withstanding at least a majority of pressure generated during the combination of the propellant grain 220 when the rocket launches. The external wall 230 may withstand the temperatures generated during the combustion of the propellant. For example, the external wall 230 may be formed of suitable rigid materials such as metals (including metallic elements and metallic alloys) such as titanium, titanium alloys, Inconel or other nickel alloys, aluminum, aluminum alloys, and steel, composite materials such as carbon-fiber-reinforced polymers and other suitable polymers, or any combination thereof.

The external wall 230 includes two sides that may be referred to as an external surface 232 and an internal surface 234. The external surface 232 may be the visual surface of the motor case 110 and may receive painting, coating, and other surface marks. The internal surface 234 is the surface that faces the passage space 270 in which the ablative layer 240 is located. The internal surface 234 may be referred to as a passage space-facing surface or an insulator-carrying surface 234 because it is the surface that carries the ablative layer 240.

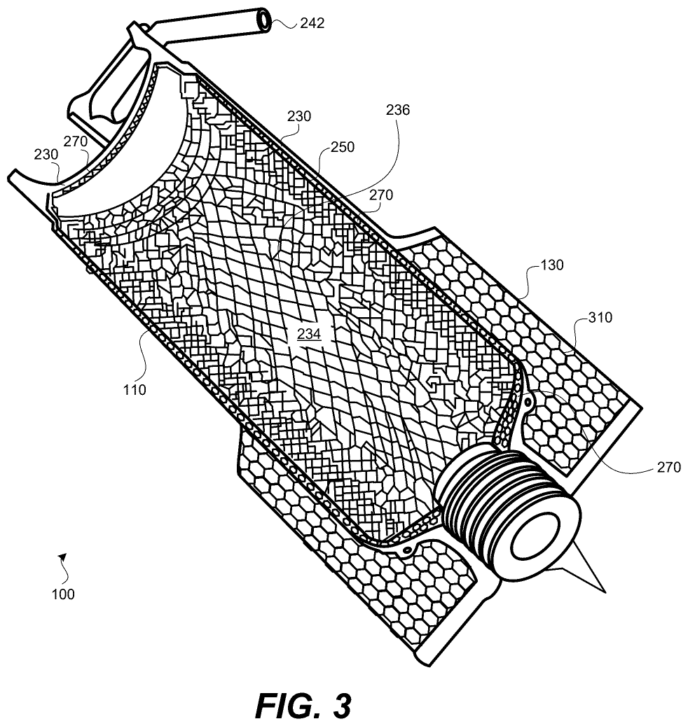

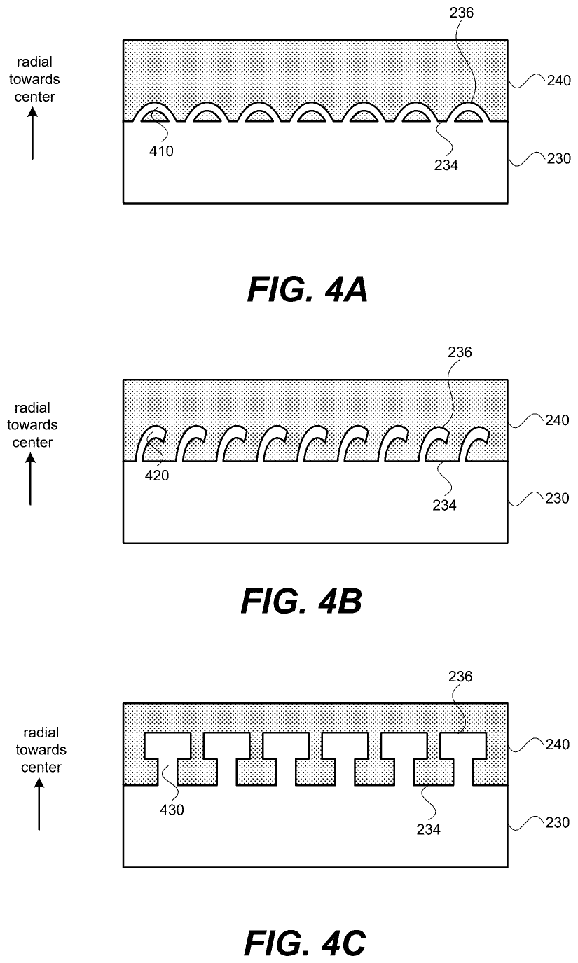

In various embodiments, the insulator-carrying surface 234 may take different forms. For example, in some embodiments, the insulator-carrying surface 234 may be a smooth surface. In some embodiments, such as the example shown in the enlarged view of the inset 260, the insulator-carrying surface 234 is not a smooth surface. Instead, the insulator-carrying surface 234 may include a set of surface structures 236 that are shaped to provide mechanical retention of the ablative layer 240. For example, the set of surface structures 236 may take the form of hook-shaped protruding members that provides retention forces in the radial direction to further hold the ablative layer 240 in place with the insulator-carrying surface 234. Various examples of shapes and arrangements of the set of surface structures 236 will be further discussed below in association with FIG. 3 through FIG. 4C.

The ablative layer 240 is an insulation layer that is formed of an ablative material in the passage space 270. In FIG. 2, the ablative layer 240 is illustrated as a layer filled with a dotted pattern. The ablative layer 240 serves as a protective material that mitigates the direct heat transfer to the external wall 230. During the rocket operation, the ablative layer 240 is gradually burned and vaporized away to create a thermal barrier that protects the structural integrity of the motor case 110. The ablative material of the ablative layer 240 may be a mixed material that includes any suitable compositions, such as ethylene propylene diene monomer (EPDM) rubber, phenolic composites, carbon fibers, ceramics, foams, or any combination thereof. As discussed further below, the ablative layer 240 may be formed by injecting the ablative material (whether a single material or a mixture) into the passage space 270 formed between the external wall 230 and the internal wall 250, and curing the ablative material to form the ablative layer. In some embodiments, since an injection molding process is used, the ablative material may fill any irregular spaces and other hard-to-reach spaces formed by surface structures 236 of the external wall 230.

In some embodiments, the external wall 230 may include an injection inlet 242 to allow the ablative material to be injected into the passage space 270. In FIG. 2, injection inlet 242 is only conceptually illustrated. For example, the injection inlet 242 may include a longer passageway and take the form of a more circuitous shape to prevent the reverse flow of the ablative material. In some embodiments, the injection inlet 242 may be sealed after the ablative layer 240 is cured. In some embodiments, the injection inlet 242 may include a cap to seal the inlet, such as taking the form of one of the inlets 140 illustrated in FIG. 1.

In some embodiments, the passage space 270 may also be extended to the area of the nozzle 120. This configuration is not shown in FIG. 2. The extension of the passage space 270 allows the linking of the passage space 270 in the motor case 110 to the passage space of the nozzle so that the ablative layer 240 extends to the nozzle area. This allows simultaneous sealing of the nozzle 120 and insulation between the nozzle 120 and the motor case 110.

The internal wall 250 helps the external wall 230 to define the passage space 270 in which the ablative layer 240 is located. The internal wall 250 is internal to the ablative layer 240 and the external wall 230 in at least the radial direction. The internal wall 250 includes two sides that may be referred to as a passage space facing surface 252 and an interior surface 254 that is facing the combustion chamber 210. The passage space facing surface 252 of the internal wall 250 and the insulator-carrying surface 234 of the external wall 230 are spaced apart from each other and together define the passage space 270 for the ablative layer 240 to form.

In some embodiments, the external wall 230 and the internal wall 250 may be a monolithic piece that is formed by an additive manufacturing process. For example, through an additive manufacturing process such as 3D printing, both the external wall 230 and the internal wall 250 may be formed as a single integral piece that includes various structural linkages 256 that allow the two walls to be spaced apart while being connected together as a monolithic piece. The additive manufacturing process may allow the passage space 270 to be formed as part of the manufacturing process. Conventionally, without using additive manufacturing, forming such a passage space 270 can be a complex labor-intensive process. The bonding between the external wall 230 and the internal wall 250 may also be challenging without additive manufacturing.

The material used to form the internal wall 250 may be the same as the external wall 230. For example, suitable rigid materials may be used, such as metals (including metallic elements and metallic alloys) such as titanium, titanium alloys, Inconel or other nickel alloys, aluminum, aluminum alloys, and steel, composite materials such as carbon-fiber-reinforced polymers and other suitable polymers, or any combination thereof. In some embodiments, due to the different roles of the external wall 230 and the internal wall 250, the internal wall 250 may also be formed of a material different from that of the external wall 230. For example, in an additive manufacturing process, different metallic particles may be deposited onto the structure being formed. As the 3D printer transition from a region of the external wall 230 to a region of the internal wall 250, the material may be switched so that the two walls of different materials may be formed integrally.

In some embodiments, the internal wall 250 may have a thickness that is significantly lower than that of the external wall 230. For example, while the external wall 230 may serve as the pressure-boundary wall, the internal wall 250 may serve to only help define the passage space 270 for the ablative layer 240 to cure therewithin. In some embodiments, the internal wall 250 is intended to be sacrificial and burned away during the combustion of the propellant grain 220 to expose the ablative layer 240. As such, in some embodiments, the external wall 230 may be referred to as a thick wall and the internal wall 250 may be referred to as a thin wall or a sacrificial wall. In some embodiments, to conserve material and to allow the ablative layer 240 to be exposed, the internal wall 250 may be of a thickness that is as thin as possible provided that the internal wall 250 is of sufficient thickness to be formed using the additive manufacturing process. For example, in some embodiments, the additive manufacturing process and the materials used may create a limit on how thin the internal wall 250 is without structurally collapsing. In some embodiments, the thin internal wall 250 may also have a sufficient thickness to withstand the pressure of the injection molding process of forming the ablative layer 240. For example, based on the combustion profile of the propellant grain 220, the ablative layer 240 may be designed to have a certain thickness and structure. In some embodiments, since the internal wall 250 is intended to form the passage space 270 for the injection molding of the ablative layer 240, the internal wall 250 may need to have the sufficient thickness to allow the ablative material to be properly cured.

In some embodiments, the internal wall 250 may be sacrificial in nature. For example, after the curing of the ablative material to form ablative layer 240, in some embodiments, the internal wall 250 is no longer needed. In some embodiments, the internal wall 250 will be the first layer to be burned away during the combustion of the propellant grain 220. In such a case, the internal wall 250 may also be referred to as a sacrificial wall. In some embodiments, after the curing of the ablative layer 240, the internal wall 250 may be removed, such as being machined away to expose the ablative layer 240. Various extents of

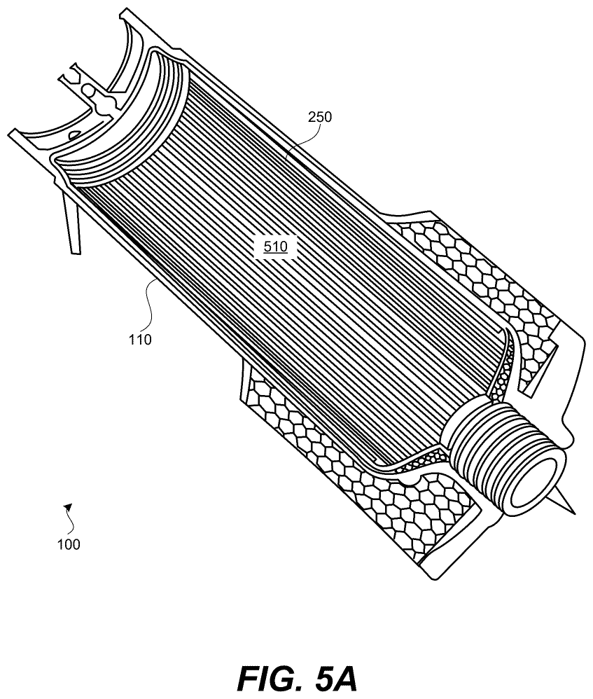

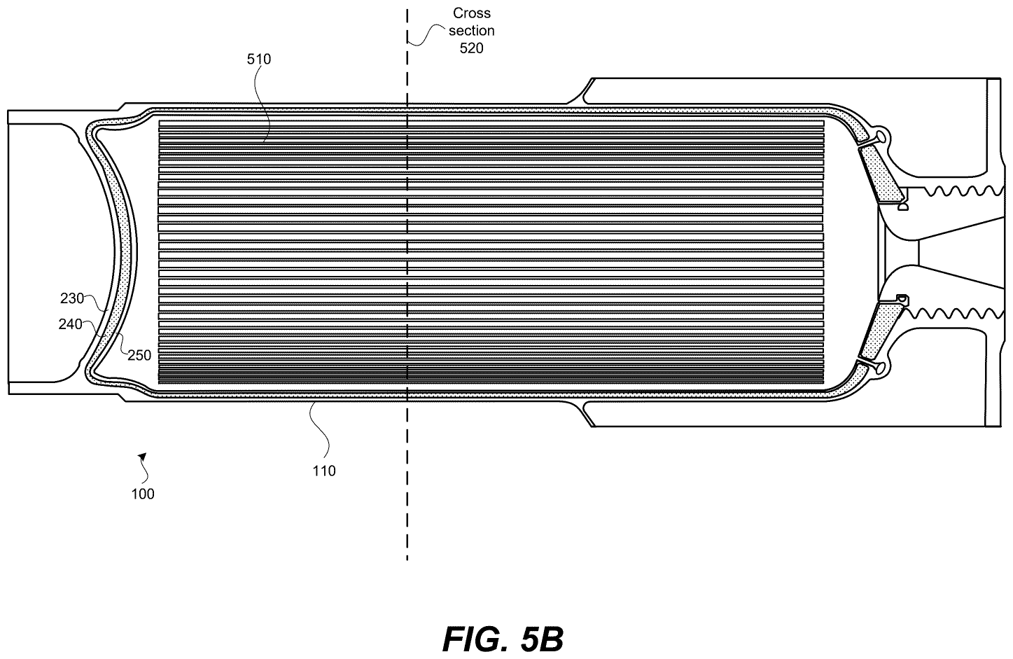

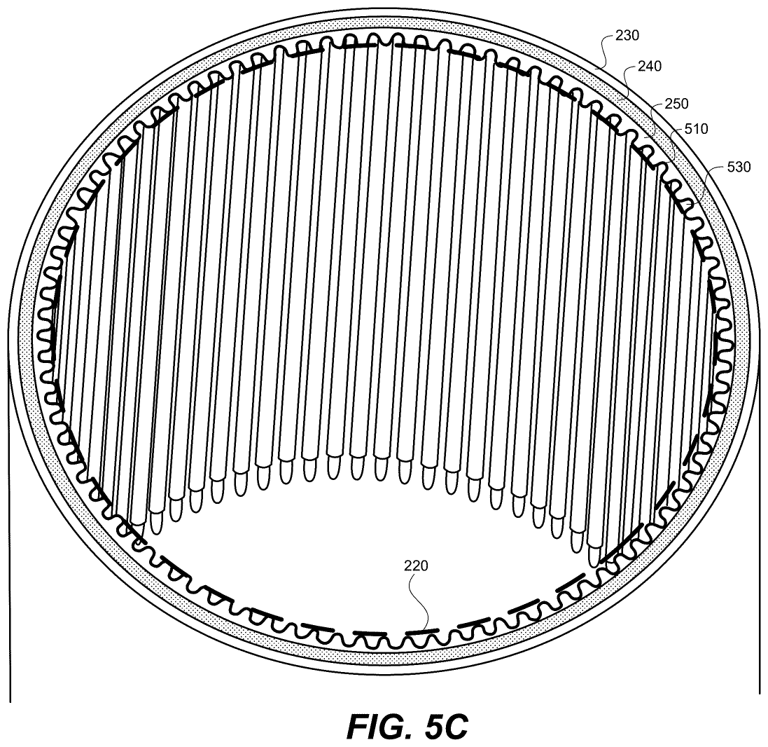

In some embodiments, the internal wall 250 may take the form of a liner geometry that will be further illustrated in FIG. 5A through FIG. 5C. The internal wall 250 may serve as a liner that is bonded to the propellant grain 220 to inhibit combustion on the propellant grain 220 and to mechanically couple the propellant grain to the motor case 110. The liner geometry, which will be further illustrated in FIG. 5A through FIG. 5C, radially weakens the mechanical structure of the internal wall 250 such that the internal wall 250 has similar mechanical properties such as stiffness as the propellant grain 220.

### Outer Wall Surface Retention Structure

FIG. 3 is a cutaway perspective view of an example motor case 110 of a rocket motor 100, in accordance with some embodiments. FIG. 3 illustrates an example of a set of surface structures 236 of the external wall 230 and the injection inlet 242 for the injection molding of the ablative material.

The external wall 230 and the internal wall 250 are spaced apart to form a passage space 270. The ablative material can be injected through the injection inlet 242 to fill the passage space 270. After the curing of the ablative material, the ablative layer 240 (not shown in FIG. 3) is formed within the passage space 270. Thereafter, the injection inlet 242 may be sealed or even removed from the motor case 110.

In FIG. 3, for the purpose of illustration, the majority of the internal wall 250 is removed from the illustration to expose the surface structure of insulator-carrying surface 234. In some embodiments, the insulator-carrying surface 234 may include a surface lattice structure as shown in FIG. 3. The surface lattice structure, which may be part of the surface structures 236, promotes the retention of the ablative layer 240 by increasing the friction between the insulator-carrying surface 234 and the ablative layer 240. In some embodiments, the surface structures 236 may be formed as part of the additive manufacturing process. As additive manufacturing provides a wide degree of flexibility in forming surface shapes, the surface structures 236 may take various different forms and are not limited to the pattern that is graphically illustrated in FIG. 3. The surface structures 236 may take the form of any mechanical retention structure that promotes the retention of ablative layer 240. Depending on the configuration and the shape of the surface structures 236, the surface structures 236 may be referred to as lattice structures, reticulated structures, nested structures, meshed structures, matrix structures, porous structures, honeycomb-like structures (even though individual units in the surface structures 236 may or may not be hexagonal), foamed structures, fanned structures, corrugated structures. The surface structures 236 may or may not be formed by individual units. For surface structures 236 that are visually identifiable with individual units, the units may have the same or different shapes. The shapes may be circles, polygons, such as triangles, squares, trapezoids, hexagons, or any suitable shapes, regular or irregular, symmetrical or asymmetrical, equally sized or not. The pattern of the surface structures 236 may also be repetitive or random, regular or irregular, symmetrical or asymmetrical, visually identifiable or not.

In some embodiments, the rocket fins 130 may also be formed as a monolithic piece of the motor case 110 through an additive manufacturing process. In such embodiments, the rocket fins 130 may also internally include a lattice structure 310 similar to the surface structures 236 to reduce the weight and increase the mechanical strength of the rocket fins 130.

FIG. 4A through FIG. 4C are cross-sectional conceptual diagrams of various examples of surface structures of an external wall 230 that are used to promote the mechanical retention of the ablative layer 240, in accordance with some embodiments. The figures further illustrate various possibilities of different sets of surface structures 236 that may be present on the insulator-carrying surface 234 of an external wall 230, in accordance with some embodiments. An insulator-carrying surface 234 may include radially protruding members that serve as the surface structures 236. The protruding members may be part of the monolithic piece of the external wall 230 formed through an additive manufacturing process. Since an additive manufacturing process allows a wide range of shapes and arrangements, the protruding members may take any shapes and forms, such as the bridge shape shown in FIG. 4A, the hook shape shown in FIG. 4B, and the T shape shown in FIG. 4C. The various protruding members shown in FIGS. 4A, 4B, and 4C are merely non-exhaustive examples of surface structures 236 that may be carried by an insulator-carrying surface 234. In various embodiments, the protruding members may include a single type or mixed type, be distributed regularly or randomly, and take the form of regular or irregular shapes. In some embodiments, the protruding members may be arranged and shaped in a way that increases the retention force in the radial direction, such as by forming any interlocking structure such as the bridge-shaped members in FIG. 4A that trap some of the ablative material and provides mechanical constrain to prevent detachment of the ablative layer 240 such as the hook-shaped members in FIG. 4B and the T-shaped members in FIG. 4C. In some embodiments, a protruding member may create a hole that traps some of the ablative materials, such as in the case of the protruding member 410. In some embodiments, a protruding member may have a first width that is wider than a second width at a level that is closer to the insulator-carrying surface 234. For example, for the protruding member 420 and the protruding member 430 both are wider at a level more towards the center compared to a level closer to the insulator-carrying surface 234.

The various example surface structures 236 illustrated in FIGS. 3, 4A, 4B, and 4C can be combined in different embodiments.

### Inner Wall Liner Structure

FIG. 5A is a cutaway perspective view of an example motor case 110 a rocket motor 100, in accordance with some embodiments. FIG. 5A illustrates an example liner structure 510 of the internal wall 250. FIG. 5B is a cross-sectional view of a rocket motor 100 illustrating the line structure 510, in accordance with some embodiments. FIG. 5C is a cut view of the motor case 110 at the cross-section 520 of FIG. 5B to further illustrate the liner structure 510, in accordance with some embodiments. FIGS. 5A, 5B, and 5C are discussed in conjunction with each other. Note that compared to FIG. 3 that illustrates the surface structures 236 of the insulator-carrying surface 234 of the external wall 230, FIG. 5A illustrates an example of the liner structure 510 that forms the interior surface of the internal wall 250. In some embodiments, a motor case 110 includes both the surface structures 236 on the external wall 230 that is illustrated in FIG. 3 and the liner structure 510 of the internal wall 250 that is illustrated in FIG. 5A through FIG. 5C. In some embodiments, both the surface structures 236 of the external wall 230 and the liner structure 510 of the internal wall 250 are formed as part of a monolithic piece through an additive manufacturing process.

In FIG. 5B, compared to FIG. 2, the propellant grain 220 is not shown to show the liner structure 510 of the internal wall 250. In some embodiments, the length of the liner structure 510 is longer than the length of the propellant grain 220 to cover the entire propellant grain 220. In some embodiments, the boundary of the liner structure 510 is at least appropriately flush with the propellant grain 220. The propellant grain 220 is conceptually illustrated by the dashed line in FIG. 5C.

In some embodiments, the liner structure 510 of the internal wall 250 may take the form of a liner geometry that is best shown in FIG. 5C. The liner geometry may take the form of a corrugated geometry or any geometry that may weaken the liner structure 510. The liner structure 510 is configured to be in contact with and sometimes be bonded to the propellant grain 220 to inhibit combustion on the propellant grain 220 and to mechanically couple the propellant grain to the motor case 110. The liner structure 510 radially weakens the mechanical structure of the internal wall 250 such that the internal wall 250 has similar mechanical properties such as stiffness as the propellant grain 220. For example, the propellant grain 220 may be associated with a first value of Young's modulus that typically ranges from 100 PSI to 1000 PSI. In some embodiments, the internal wall 250 forms a metallic liner that is intended to weaken the stiffness of the internal wall 250 so that the liner structure has a stress curve and/or strain curve that is comparable to the propellant grain 220. In some embodiments, at least in the radial direction, the liner structure 510 has a second value of Young's modulus that is comparable to the Young's modulus of the propellant grain 220. For example, in some embodiments, the second value may be in the range of 50% to 200% of the first value. In some embodiments, the second value may have the same order of magnitude as the first valuc. In some embodiments, the second value may be larger than the first value, but is within 2 times of the first value. In some embodiments, the second value may be larger than the first value, but is within 3 times of the first value. In some embodiments, the second value may be larger than the first value, but is within 4 times of the first value. In some embodiments, the second value may be larger than the first value, but is within 5 times of the first value. In some embodiments, the second value may be within 10 times of the first value. The reduced mechanical strength of the liner structure 510 protects the propellant grain 220 by reducing the pressure exerted on the propellant grain 220.

In various embodiments, the liner structure 510 may take various different forms, such as the liner geometry shown in the figures or another structure that will reduce the overall mechanical structure of the internal wall 250. In some embodiments, the internal wall 250 may be made of a metallic material. The use of a metallic liner reduces the complexity of manufacturing the motor case 110 because the liner structure 510 may be directly formed using additive manufacturing without a complex machining process, and at the same time the formation of the internal wall 250 allows the passage space 270 to be formed for the ablative layer 240. In some embodiments, the liner structure 510 may take any suitable form that reduces the mechanical strength of the internal wall 250 at least in the radial direction, whether the form is regular or irregular, alternating or random, symmetric or asymmetric, and repeating or not.

In some embodiments, the liner structure 510 also creates space 530 (illustrated in FIG. 5C) between the liner structure 510 and propellant grain 220. The liner structure forming the space 530 allow external pressurization of the propellant grain 220 so that, during the combustion of the propellant grain 220, the combustion gas is able to pass around the outer diameter of the propellant grain 220 up to the head end of the combustion chamber 210, thus creating an improved airflow of the combustion gas towards the nozzle 120.

### Example Manufacturing Process

FIG. 6 is a flowchart depicting an example process 600 for making a motor case 110, in accordance with some embodiments. The motor case 110 made by the process 600 may include any of the structural and configuration features illustrated in any of the preceding figures, such as the motor case 110 being a monolithic piece, the motor case 110 having the passage space 270 for holding the ablative layer 240, the motor case 110 having an external wall 230 that has any of the surface structures 236 illustrated in FIGS. 3, 4A, 4B, and 4C, and/or the motor case 110 having an internal wall 250 that has the liner structure 510.

In some embodiments, the process 600 may include performing 610 an additive manufacturing process to form a motor case 110. The additive manufacturing process may be a 3D printing process such as a power bed fusion (PBF) process. The process may add material (e.g., metallic powers) layer by layer. The material that may be used is further discussed above with reference to FIG. 2. In some embodiments, a heat source such as a laser or an electron beam may be used to sinter powdered material and the material is deposed on a previously formed layer. In some embodiments, the additive process may be progressed along the longitudinal direction to build the motor case 110, whether the progress is from the nozzle 120 to the upper body, or from the upper body to the nozzle 120.

In some embodiments, as part of the additive manufacturing process, a first wall of the motor case 110 may be formed. The first wall may include an insulator-carrying surface 234. For example, the first wall may be the external wall 230 that may serve as the pressure-boundary wall of the motor case 110. In some embodiments, as part of the additive manufacturing process, a set of surface structures 236 is formed on the insulator-carrying surface 234. For example, any surface structures 236 discussed above, whether explicitly illustrated in the figures or not, may be formed as part of the additive manufacturing process.

Additionally, or alternatively, in some embodiments, as part of the additive manufacturing process, a second wall of the motor case 110 may be formed. The second wall may be the internal wall 250 that is spaced apart from the external wall 230 so that a passage space 270 is created between the external wall 230 and the internal wall 250. In some embodiments, the external wall 230 and the internal wall 250 are part of a monolithic piece. In some embodiments, as part of the additive manufacturing process, one or more structural linkages 256 are also formed so that the internal wall 250 is secured to the external wall 230.

Additionally, or alternatively, in some embodiments, as part of the additive manufacturing process, a liner structure 510 of the second wall may be formed. Alternatively, in some embodiments, another type of liner may be used in place of the liner structure 510.

Continuing with FIG. 6, the process 600 may include forming 620 an ablative layer 240 on the insulator-carrying surface 234 of the motor case 110. In some embodiments, the surface structures 236 formed by the additive manufacturing process is shaped to provide mechanical retention of the ablative layer 240.

In various embodiments, the forming 620 of the ablative layer 240 on the insulator-carrying surface 234 may be performed in different suitable ways. For example, in some embodiments, if the additive manufacturing process forms both the external wall 230 and the internal wall 250 so that a passage space 270 is created, the forming 620 of the ablative layer 240 may include injecting an ablative material into the passage space 270 between the external wall 230 and the internal wall 250, such as through an injection inlet 242. In turn, the forming 620 of the ablative layer 240 may include curing the ablative material to form an ablative layer 240 between the external wall 230 and the internal wall 250 of the motor case 110. In some embodiments, the process 600 may further include removing the injection inlet 242 and/or sealing the injection inlet 242 such as by cutting most of the conduit of the injection inlet 242 and sealing part of the inlet by any suitable method such as applying a cap, welding, etc. The sealing of the passage space 270 prevents the ablative material from outflowing from the passage space.

In some embodiments, the additive manufacturing process may only form a single wall that has the insulator-carrying surface 234 that includes various surface structures 236 discussed above. In those embodiments, the forming 620 of the ablative layer 240 may include other suitable methods such as by coating the ablative material on the insulator-carrying surface 234 or by any other suitable application method.

In some embodiments, after the motor case 110 and the ablative layer 240 are formed, a propellant may be injected into the combustion chamber 210 through an opening such as the nozzle 120. The propellant may be solidified to form the propellant grain 220. The liner structure 510 may serve to protect the propellant grain 220.

### Additional Considerations

The foregoing description of the embodiments has been presented for the purpose of illustration; it is not intended to be exhaustive or to limit the patent rights to the precise forms disclosed. While particular embodiments and applications have been illustrated and described, it is to be understood that the invention is not limited to the precise construction and components disclosed herein and that various modifications, changes and variations which will be apparent to those skilled in the art may be made in the arrangement, operation and details of the method and apparatus disclosed herein without departing from the spirit and scope of the present disclosure. Persons skilled in the relevant art can appreciate that many modifications and variations are possible in light of the above disclosure.

The term “steps” does not mandate or imply a particular order. For example, while this disclosure may describe a process that includes multiple steps sequentially with arrows present in a flowchart, the steps in the process do not need to be performed by the specific order claimed or described in the disclosure. Some steps may be performed before others even though the other steps are claimed or described first in this disclosure. Likewise, any use of (i), (ii), (iii), etc., or (a), (b), (c), etc. in the specification or in the claims, unless specified, is used to better enumerate items or steps and also does not mandate a particular order.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. In addition, the term “each” used in the specification and claims does not imply that every or all elements in a group need to fit the description associated with the term “each.” For example, “each member is associated with element A” does not imply that all members are associated with an element A. Instead, the term “each” only implies that a member (of some of the members), in a singular form, is associated with an element A. In claims, the use of a singular form of a noun may imply at least one element even though a plural form is not used.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hercon. Accordingly, the disclosure of the embodiments is intended to be illustrative, but not limiting, of the scope of the patent rights.

1. A rocket motor comprising:
a combustion chamber configured to carry propellant for propelling the rocket;
a motor case enclosing the combustion chamber, the motor case comprising an external wall and an internal wall that is spaced apart from the external wall to form a passage space between the external wall and the internal wall, wherein the external wall has an insulator-carrying surface;
an ablative layer carried by the insulator-carrying surface of the external wall of the motor case; and
a set of surface structures on the insulator-carrying surface, wherein the set of surface structures are shaped to provide mechanical retention of the ablative layer.

2. The rocket motor of claim 1, wherein the wall is an external wall, the motor case further comprises an internal wall that is spaced apart from the external wall to form a passage space between the internal wall and the external wall, and the ablative layer is located in the passage space.

3. The rocket motor of claim 2, wherein the external wall and the internal wall are part of a monolithic piece formed from an additive manufacturing process.

4. The rocket motor of claim 2, wherein the ablative layer is formed of an ablative material that is injection molded into the passage space.

5. The rocket motor of claim 2, wherein the insulator-carrying surface faces the passage space.

6. The rocket motor of claim 2, wherein the internal wall is thinner than the external wall and is configured to be sacrificial during combustion of the propellant.

7. The rocket motor of claim 1, wherein the set of surface structures comprises a lattice surface structure. 8 (Original) The rocket motor of claim 1, wherein the set of surface structures comprises a radially protruding member that has a first width that is wider than a second width at a level that is closer to the insulator-carrying surface.

9. The rocket motor of claim 1, wherein the propellant is a solid propellant grain that is in contact with a second wall of the motor case.

10. The rocket motor of claim 1, wherein the set of surface structures comprise a plurality of hook-shaped members.

11. A method for making a rocket motor, the method comprising:
performing an additive manufacturing process to form a motor case that comprises an external wall and an internal wall that is spaced apart from the external wall to form a passage space between the external wall and the internal wall, wherein the external wall has an insulator-carrying surface;
forming, as part of the additive manufacturing process, a set of surface structures on the insulator-carrying surface; and
forming an ablative layer on the insulator-carrying surface of the external wall of the motor case, wherein the set of surface structures are formed by the additive manufacturing process to be shaped to provide mechanical retention of the ablative layer.

12. The method of claim 11, wherein the motor case is a monolithic piece that is formed by the additive manufacturing process, the monolithic piece comprises the wall and an internal wall that is internal to and spaced apart from the wall to form a passage space between the wall and the internal wall, and the set of surface structures on the insulator-carrying surface faces the passage space.

13. The method of claim 12, wherein forming the ablative layer on the insulator-carrying surface of the wall of the motor case comprises:
injecting an ablative material into the passage space between the internal wall and the wall; and
curing the ablative material to form an ablative layer between the internal wall and the wall of the motor case.

14. The method of claim 13, further comprising sealing the passage space to prevent the ablative material from outflowing from the passage space.

15. The method of claim 11, wherein the set of surface structures comprise a plurality of hook-shaped members.

16. The method of claim 11, wherein the motor case has a longitudinal body, and the additive manufacturing process is progressed along a longitudinal direction to build the motor case.

17. The method of claim 11, wherein the set of surface structures comprises a lattice surface structure.

18. The method of claim 11, wherein the set of surface structures comprises a radially protruding member.

19. The method of claim 18, wherein the radially protruding member has a first width that is wider than a second width at a level that is closer to the insulator-carrying surface.

20. The method of claim 18, wherein the radially protruding member is formed as part of the additive manufacturing process.
